(19) United States
(12) Patent Application Publication
(10) Pub. No.: US 2013/0276102 A1
(43) Pub. Date: Oct. 17, 2013

(54) Methods and systems for enabling a secure password entry using a non-secure device

(71) Applicant: ABINE LIMITED, Road Town (VG)

(72) Inventors: Francois Johannes Rautenbach, Centurion (ZA); Stafford Clint Masie, Gauteng (ZA)

(73) Assignee: ABINE LIMITED, Road Town (VG)

(21) Appl. No.: 13/793,485

(22) Filed: Mar. 11, 2013

Related U.S. Application Data
(63) Continuation-in-part of application No. 13/654,107, filed on Oct. 17, 2012.

(30) Foreign Application Priority Data
Apr. 13, 2012 (ZA) 2012/02743
Sep. 17, 2012 (EP) 12184752.9

(51) Int. Cl. G06F 21/36

(52) U.S. Cl. CPC G06F 21/36
USPC 726/19

(57) ABSTRACT

A system and method provide for adjusting a random character or sequence of random characters. A random character or the sequence can be computed and displayed by a first device, and adjusted in response to user input from a second device. In response to user input correctly adjusting the displayed random character or sequence to match a password, the first device generates an output signal that can effect a financial transaction to occur. The password can correspond to a banking card PIN. The user input can comprise a series of offsets having values of plus one (+1), minus one (−1), or some other offset amount. The random sequence can include multiple digits (for example, numbers or letters). The first device can display the adjusted random character and replace digits of the displayed adjusted random sequence with unrelated typographical symbols, such as an asterisk (*).

This application is a continuation-in-part application of U.S. patent application Ser. No. 13/654,107 filed Oct. 17, 2012, and this application claims priority benefits under 35 U.S.C. §119 to South African Patent Application No. 2012/02743 filed Apr. 13, 2012 and European Patent Application No. 12184752.9 filed Sep. 17, 2012. South African Patent Application No. 2012/02743, European Patent Application No. 12184752.9, and U.S. patent application Ser. No. 13/654,107 are hereby incorporated by reference.

### FIELD

This application relates to methods and systems for enabling a secure password entry using a non-secure device.

### BACKGROUND

In modern society a secure personal identification number (PIN), access code, password or the like is often required to, for example, gain access to a secure system or to authorise a transaction e.g., on a Point of Sale (POS) terminal.

It is well known that conventional PIN or password entry devices (such as keyboards, keypads, touch screens, etc.) can easily be compromised by rogue software (such as Trojans, viruses, spyware and the like). Similarly, data input (in the form of keystrokes, touch input, mouse movements and the like) as well as data output (in the form of screen, display, printouts) may be recorded maliciously from these devices.

In this respect, it is generally known by those in the industry, that the majority of such input devices that do not actively provide a tamper-resistant mechanism are susceptible to data input detection techniques. Devices such as these are therefore generally known as non-secure devices. Examples of such non-secure devices include personal computers, mobile phones, tablet computers, personal digital assistants, and the like.

From a security perspective, such a non-secure device cannot generally be regarded as acceptable for secure PIN, access code or password entry. It will be appreciated that as a result, a need exists in the industry, for a system that through the use of a non-secure device, is still able to provide a secure method of password entry.

Existing mechanisms of PIN or password entry on a Point of Sale (POS) terminal or the like includes the use of a conventional keypad. It is to be appreciated that in accordance with conventional functioning, the digits of the PIN which are entered onto the keypad are never displayed on the device. Instead, a corresponding number of unrelated typographical characters such as an asterisk (*) or the like are displayed on the device, so as to avoid detection of the password entered, by third parties.

However, it is to be appreciated that conventional keypads of the above nature are vulnerable to attack from third parties through the detection of a user's hand movements, use of recording devices such as Closed Circuit Television (CCTV) cameras or the like, side views of the PIN entry keypad being possible as well as through techniques such as key heat mapping. It is therefore to be appreciated that a further need exists in the industry for a more secure means of password entry than that which is currently available.

### SUMMARY

In a first respect, there is provided a method of enabling a secure password entry using a non-secure device, said method comprising: (i) computing and displaying one or more random characters on a secure peripheral device, (ii) adjusting said displayed one more random characters on said secure device, in response to a user manipulating a password entry mechanism on said non-secure device and an event signal being sent to the secure device, (iii) replacing one or more digits of said displayed password on said secure device with one or more unrelated symbols after a determined amount of time, and (iv) generating an output signal, in response to said user correctly adjusting said displayed one or more random characters to one or more digits of a determined password.

In an example embodiment, said step of generating an output signal includes sending a signal to effect a financial transaction between a banking account and an external vendor. In this example embodiment, said step of generating an output signal and effecting a financial transaction in response to said secure device correctly displaying said determined password, includes approving an underlying transaction between a bank account associated with a banking card and an external, peripheral system.

In an example embodiment, the adjustment of said displayed random character includes said non-secure device transmitting to said secure display unit an indication of said user's adjustment of said displayed password. In this example embodiment, the adjustment of said displayed random character includes said non-secure device sending an event signal to the secure device causing it to increment the character displayed on the secure device by either an entropy of plus one (+1) or an entropy of minus one (−1). In this example embodiment, said determined password corresponds to a Personal Identification Number (PIN) of said banking card, said banking card being associated with said banking account of said user.

In an example embodiment, said method further comprises the user accepting the adjustment of the displayed random character as correct, in response to which an accept command will be sent to said non-secure device. In this example embodiment, said secure peripheral device will display another randomly generated character in a next password digit position, in response to receiving said accept command from said non-secure device. In this embodiment, said adjustment provided to said secure device is provided in increments of plus one. In this embodiment, said method includes manipulating said password entry mechanism on said non-secure device so as to adjust said password displayed on the secure device in increments of plus one.

In an example embodiment, said method further comprises said non-secure device transmitting an accept command to said secure display unit, in response to said secure device correctly displaying a determined password of said user.

In another respect, there is provided a system for enabling a secure password entry using a non-secure device, said system comprising: (i) a peripheral secure device, including: a random character generation means, an interfacing means, operable to interface to a non-secure device, and a display and concealment means, operable to display said random character and an adjustment of said random character, and (ii) a non-secure device, including: a random character adjustment means, operable to transfer a determined event signal to said secure device in response to an adjustment request being created by a user with regard to said random character displayed on the secure device, and an interfacing means, operable to transfer said event signal to a peripheral secure device, so as to manipulate the password entry, wherein said system is operable to generate an output signal, in response to a determined password being correctly displayed on said secure device.

In an example embodiment, said generation of an output signal includes sending a signal so as to effect a financial transaction between a banking account and an external vendor.

In an example embodiment, said concealment means includes a display means operable to restrict visibility of said password display to a user of said secure device. In a further embodiment, said concealment means further includes a password entry replacement means, operable to replace display of said one or more digits of said password with one or more unrelated symbols.

In an example embodiment, said random character adjustment means is provided in the form of a touch screen with visible cues in the form of a slider or the like. In an alternative embodiment, said random character adjustment means is provided in the form of a keyboard, any key press, a mouse scroll, a click of a mouse button, touch or movement on a track pad or another means of data input such as voice, gestures or physical device movements.

In an example embodiment, said secure device and said non-secure device are provided in the form of separate, independent units. In an alternative embodiment, said secure device and said non-secure device are provided in the form of a single, integrated unit.

In an example embodiment, said non-secure device is provided in the form of a mobile device. In this embodiment, said mobile device may be provided in the example form of a cellular telephone, a laptop, a personal digital assistant, personal computer, tablet or other portable computing device or the like.

In an example embodiment, said random character adjustment means is any mechanism operable to initiate a determined event signal, operable to be transmitted to said secure device.

In an example embodiment, said secure display unit is tamper proof.

In yet another respect, there is provided a method of effecting a financial transaction, said method comprising: initiating a financial transaction in response to a signal received from a system, said system comprising a non-secure device in communication with a peripheral secure device, wherein said peripheral secure device includes: (i) a random character generation means, (ii) an interfacing means, operable to interface to a non-secure device, and (iii) a display and concealment means, operable to display said random character and an adjustment of said random number, and wherein said non-secure device includes: a random character adjustment means, operable to transmit a determined event signal to said secure device in response to each plus one adjustment of said displayed random character by a user, and an interfacing means, operable to transfer a determined event signal to said peripheral secure device, in response to a plus one adjustment or acceptance of said displayed random character by a user.

In yet another respect, there is provided a system for secure password entry on a non-secure device, said system including: (i) a secure display unit; and (ii) a non-secure device, operable to communicate predetermined information related to a password with said secure display device by means of a predetermined protocol and in accordance with one or more security restrictions imposed by said secure display unit, said information being inaccessible by said non-secure device, said information however being visible to a user operating said non-secure device by way of said secure display unit.

In an example embodiment, said secure display unit is attached to said non-secure device. In an embodiment, said non-secure device is provided in the form of a mobile device. In this embodiment, said mobile device may be provided in the example form of a cellular telephone, a laptop, a personal digital assistant or the like. In this embodiment, said communication of predetermined information extends to said non-secure device sending information to or requesting information from said secure display device.

In an example embodiment, said secure display unit is a tamper proof or a tamper evident device. In an embodiment, the password is provided in the form of an access code, a personal identification number (PIN) or the like.

In still yet another respect, there is provided a method of entering a secure password on a non-secure device by means of a secure display unit, said method comprising: (i) said non-secure device initiating a password entry transaction with said secure display unit, (ii) said secure display unit computing and displaying a random value for said password, and (iii) said non-secure device prompting a user to adjust the password displayed on said secure display unit so as to have said displayed password correspond to a password of a user of said non-secure device.

In an example embodiment, said password displayed on said secure display unit is adjustable by one or more means, said means including: (i) a keyboard on the non-secure device; (ii) a scroll wheel on a computer mouse, a micro-switch on a computer mouse or a surface for enhancing the usability of a computer mouse; (iii) a touch screen with visual cues in the form of an input method such as a rotatable thumbwheel, slider, knob or the like; and (iv) another means of data input such as voice, gestures or physical device movements.

In an example embodiment, said method further comprises said non-secure device transmitting to said secure display unit an indication of said user's adjustment of said displayed password. In this embodiment, said method further comprises said secure display unit updating its display to present a newly adjusted password in accordance with said user's adjustment received from said non-secure device. In this embodiment, said updating of said secure display unit takes place in a non-predictive manner.

In an example embodiment, said method further comprises said non-secure device controlling the input mechanism on said non-secure device and providing feedback to said secure display unit.

In an example embodiment, said method further comprises said non-secure device transmitting an accept command to said secure display unit once the user has acknowledged that said user's password is correctly displayed on said secure display unit.

In an example embodiment, said secure display unit is operable to hide said displayed password and perform additional processing if required.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

These and other features will become apparent from the following description with reference to the accompanying drawings in which:

FIG. 1 shows a system for enabling a secure password entry using a non-secure device, in which the example embodiments operate;

FIG. 2 shows a flow diagram of a method of enabling a secure password entry using a non-secure device, so as to effect a financial transaction with regard to the system as shown in FIG. 1, according to the example embodiments;

FIG. 3 shows a flow diagram of a method of enabling a secure password entry using a non-secure device with regard to the secure peripheral device of the system as shown in FIG. 1, according to the example embodiments;

FIG. 4 shows a machine in the example form of a mobile device within which a set of instructions, for causing the machine to perform any one or more of the methodologies discussed herein, may be executed; and

FIG. 5 shows example password adjustment messages.

### DETAILED DESCRIPTION

### I. Introduction

In this description, the articles “a” or “an” are used to introduce elements of the example embodiments. The intent of using those articles is that there is one or more of the elements. The intent of using the conjunction “or” within a described list of at least two terms is to indicate any of the listed terms or any combination of the listed terms. The use of ordinal numbers such as “first,” “second,” “third” and so on is to distinguish respective elements rather than to denote a particular order of those elements. The ordinal numbers can be written in the form of 1^{st}, 2^{nd}, 3^{rd}, and so on.

The system, machine, and flow diagrams shown in the figures are provided merely as examples and are not intended to be limiting. Many of the elements illustrated in the figures or described herein are functional elements that can be implemented as discrete or distributed components or in conjunction with other components, and in any suitable combination and location. Those skilled in the art will appreciate that other arrangements and elements (for example, machines, interfaces, functions, orders, or groupings of functions) can be used instead. Furthermore, various functions described as being performed by one or more elements can be carried out by a processor executing computer-readable program instructions or by any combination of hardware, firmware, or software.

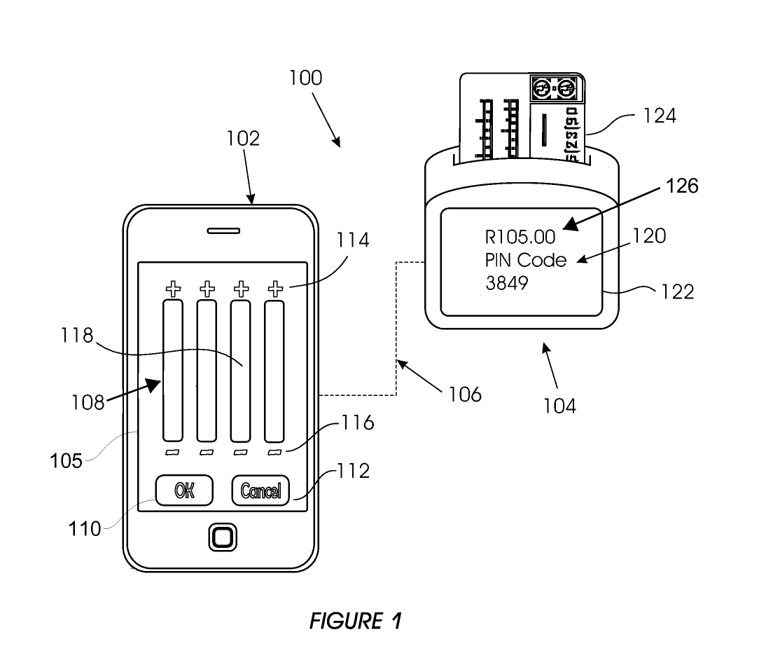

Referring to FIG. 1 of the drawings, a system for enabling a secure password entry using a non-secure device so as to effect a financial transaction is generally indicated by reference numeral 100.

For purposes of this description, a password, such as the secure password, can comprise one or more digits. By way of example, FIG. 1 shows a password (for example, a PIN code) having the four digits “3849.” Each digit of the one or more digits can, for example, be a number, a letter, or a keyboard symbol. A keyboard symbol can be any of the symbols selectable using a QWERTY keyboard, an Arabic keyboard, or some other keyboard. Examples of keyboard symbols from a QWERTY keyboard include “˜,” “!,” “@,” and “#.” A person having ordinary skill in the art will understand that keyboard symbols can be selected by devices other than a keyboard, such as a touch screen on a mobile phone. The numbers can be numbers from the set of Arabic number, the set of Chinese numbers, or some other set of numbers. The letters can letters from the set of Latin (alphabet) letters, the set of Greek (alphabet) letters, or some other set of letters.

This description refers to one or more random characters. The one or more random characters can be generated by a random character generator. A random character generator can comprise a random number generator, a random letter generator, or a random keyboard symbol generator. Each random character of the one or more random characters and each random character otherwise described in this description can, for example, be a number, a letter, or a keyboard symbol. The description above with respect to examples of the numbers, letters, and keyboard symbols is applicable to the random number characters. A random value described herein can comprise one or more random characters.

The system 100 includes a non-secure device in the example form of a mobile device 102, which in turn includes a screen display 105, a secure peripheral device in the example form of a peripheral display unit 104 which in turn includes a screen display 122. For purposes of this description, the peripheral display unit 104 is sometimes referred to as a secure display unit 104 or, more simply, a secure display 104 or display unit 104. It is to be appreciated that the mobile device 102 could be in the example form of a mobile phone. In this respect, it is to be appreciated that in one example embodiment, the system 100 may include more advanced computing ability and connectivity than that provided on a conventional feature phone. In such a scenario, the mobile device 102 will be provided in the example form of a conventional smartphone, tablet or the like.

The mobile device 102 further comprises a password entry mechanism 108 operable to adjust the password displayed on the secure display unit 104. The password entry mechanism 108 can be referred to as a password adjuster, a password adjustment means, or more simply, adjustment means. The password entry mechanism 108 is exemplified as a touch screen with visible cues in the form of an input method such as a slider 118 or slider adjustment buttons 114, 116. However, it is to be appreciated that the adjustment means 108 may be provided in the form of a keyboard, a mouse scroll, a mouse button, track pad or another means of data input such as voice, gestures or physical device movements. The abovementioned adjustment means 108 is provided on the mobile device 102, in accordance with the example embodiments. The touch screen of the mobile device 102 further comprises a submit button 110 and a cancel button 112.

It is to be appreciated that the password entry mechanism 108 is a functional module corresponding to a functional task performed by a processor of the mobile device 102. In the example embodiments, the password manipulation mechanism is facilitated by means of a software program such a software application provided on the mobile phone 102, or the like.

In accordance with the example embodiments, the mobile device 102 is a resource, which is operable to communicate determined information with the peripheral secure device 104 by means of an interfacing means, in the example form of a communication pathway 106. In accordance with the example embodiments, this communication takes places according to a determined protocol and the security restrictions imposed by the peripheral display unit 104 are adhered to. It will be appreciated that a user's password does not have to be entered on or made available to the mobile device 102. In this regard, it is to be appreciated that the password is built up of a set of random characters that are generated on the secure device and is incremented when an increment character instruction is sent from the mobile device 102 to the peripheral secure device 104, and is decremented when a decrement character instruction is sent from the mobile device to the peripheral secure device.

In accordance with the example embodiments, the peripheral secure device 104 is provided in the form of a secure, tamper proof display unit 104 that can display a password, in the example form of a Personal Identification Number (PIN) 120 or access code. More particularly, the secure device 104 includes a concealment means including a limited visibility screen, the visibility of which is limited to a user of the device. Such a limited visibility screen may be provided in the example form of a conventional privacy screen, which is well-known in the art. Such a privacy screen will, for example, include a readable screen having a 3M™ privacy filter underlying the display area. It will further be appreciated that such a privacy screen is visible from any angle, but the viewable area of the display screen is only viewable from above and does not lend itself to visibility from the three o'clock, six o'clock or nine o'clock reading positions. It is therefore to be appreciated that such a screen makes accessing the information displayed on the screen difficult from angles other than those of a user of the device.

The secure device 104 can include a random character generation means (not shown). The random character generation means can comprise a random number generator, a random letter generator, or a random keyboard symbol generator.

In accordance with an example embodiment, the secure device 104 further includes a random number generation means (not shown) which is provided in the example form of a true random number generator (TRNG) embedded in the secure device 104. In this example embodiment, the TRNG is protected against physical and environmental tampering and implements a secure hardware logic algorithm in the form of a cryptographic algorithm. This particular cryptographic algorithm generates session encryption keys in one device (in this case, in the secure device 104). These keys are then recovered in another device (such as the mobile device 102) without the keys actually being transmitted between devices. The keys are therefore completely eliminated from the realm of communication between the mobile device 102 and the secure device 104.

In addition, the random characters displayed on the secure device 104 are generated from a combination of the output of a hardware random character generator and an internal seed value, which is not externally accessible. The internal seed is stored in the Electrically Erasable Programmable Read-Only Memory (EEPROM) of the secure device 104. The seed value is therefore normally updated once after every power-up or sleep/wake cycle. After the update, this seed value is retained in registers within the chip that are validated if the chip enters sleep mode or the power is removed. Other examples of devices of the secure device 104 and the manner in which the displayed random characters are generated are also possible.

It is to be appreciated that, in accordance with the example embodiments, the PIN entry mechanism is provided by a combination of the mobile device 102 and the secure device 104. However, the mobile device 102, as an unsecured device, is decoupled from the secure device 104, in such a manner that the password provided to the secure device 104 cannot be accessed on the mobile phone 102 attached to the secure device 104.

In this example embodiment, the peripheral display unit 104 is further operable to display the amount 126 of the transaction to be processed by the system.

It is to be appreciated that the system 100 is capable of being used in the processing of payment transactions where a verifiable secure password entry mechanism is required on an unsecure device, such as a mobile phone 102.

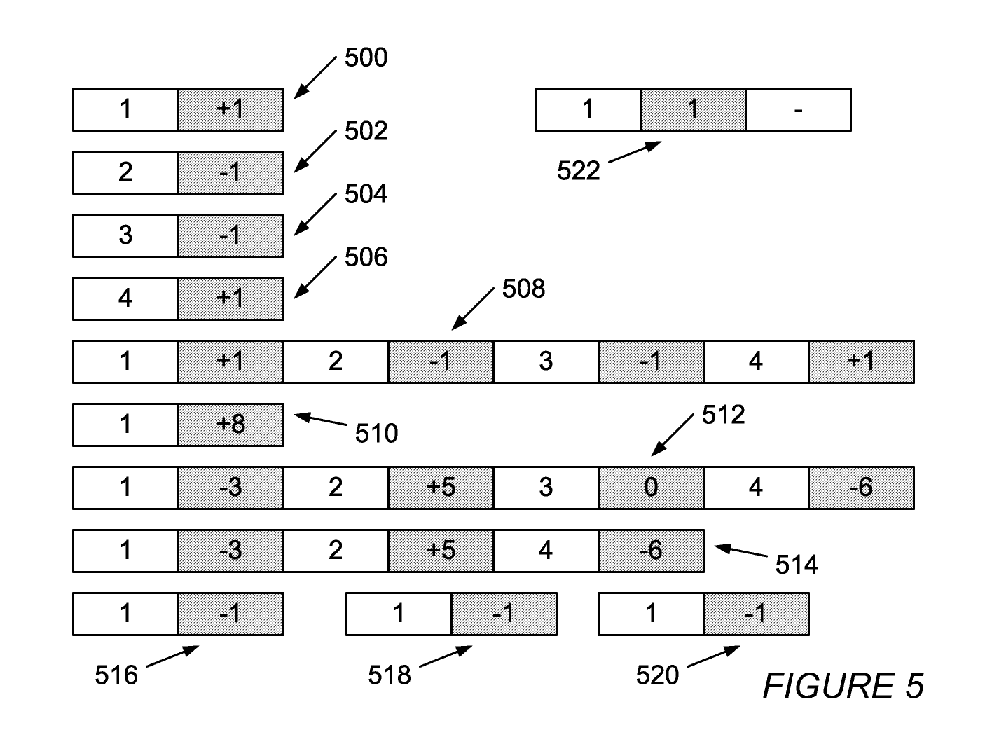

In use, the random character generated by the secure device 104 is then adjusted by a user through a manipulation of the password entry mechanism 108 on the mobile device 102. It is to be appreciated that the adjustment is communicated to the secure device 104. The adjustment (for example, one or more adjustments) can be communicated to the secure device 104 by transmission of an event signal, such as a password adjustment message. FIG. 5 shows example password adjustment messages referenced with even numbers 500 through 522 inclusive.

In accordance with one or more example embodiments in which the password has multiple digits, the mobile device 102 can transmit a password adjustment message with (i) a digit position identifier, or more simply, a digit identifier, (for example, 1 for a first digit of the password, 2 for a second digit of the password, and so on for each additional digit), and (ii) an offset value. In password adjustment messages 500 through 522, the digit identifiers are represented as numbers in the un-shaded rectangles, and the offset values are shown in the shaded rectangles. Password adjustment message 522 is an example message in which an offset to adjust a password digit includes an offset value and a separate bias sign (such as + or −). The password adjustment message 522 conveys the same information shown in each of password adjustment messages 516, 518, and 522.

A person skilled in the art will understand that each password adjustment message could include other information such as, but not limited to a header, checksum, source identifier, and destination identifier. That same skilled person will understand that for further security or other reasons, a password message or some portion of the password message can be encrypted.

In accordance with one or more example embodiments, the password adjustment can be sent in increments of plus one (+1) or decrements of minus one (−1). For those example embodiment(s), the mobile device 102 is only able to communicate an offset of plus one (+1) or minus one (−1). Password adjustment messages 500, 502, 504, 506, 508, 516, 518, 520, and 522 are examples of communicating password adjustments of plus one or minus one.

In accordance with one or more example embodiments, the password adjustment can be sent in increments or decrements of plus one, minus one, zero, a positive numerical offset other than plus one, or a negative numerical offset other than minus one. As an example, password adjustment message 510 includes an offset of plus eight (+8).

Furthermore, a password adjustment message can include a respective offset for multiple digits of the password. For example, password adjustment message 512 includes the following offsets for digits 1, 2, 3, and 4 of a password: minus three (−3), plus five (+5), zero (0), and minus six (−6). The offset of zero (0) for digit 3 can be provided via a password adjustment password if the initial random value of digit 3 matches the password or if the displayed value of digit 3 currently matches the password. Furthermore still, since no change to digit 3 of the password is needed, instead of sending a password adjustment message with an offset of zero (0), a password adjustment message with non-zero offset values for digits 1, 2, and 4 can be provided to the secure device 104. Password adjustment message 514 is an example of such a message.

A single password digit can be adjusted by providing multiple password adjustment messages. For example, digit 1 of the password can be adjusted by providing secure device 104 with password adjustment messages 516, 518, and 520 having offsets of minus one (−1) to achieve the same adjustment of digit 1 as sending password adjustment message 512 or 514.

If a first, randomly generated start value for a password digit is five (5) and the password adjustment means (for example, a toggle wheel) is adjusted eight times, a final value of three (3) will be displayed on the secure display 104 if the information conveyed between the mobile phone 102 and the secure device 104 is a plus one (+1) for each of the eight adjustments. The displayed value for the adjusted digit can sequentially as follows: 6, 7, 8, 9, 0, 1, 2, 3. In accordance with this example, the random character generator can generate characters from among the following sequence 0, 1, 2, 3, 4, 5, 6, 7, 8, 9. Other example sequences of numbers can also be defined.

In accordance with one or more example embodiments in which the random character generator comprises a random letter generator, if a first, randomly generated start value is “V” and the password adjustment means is adjusted eight (8) times to produce an offset value of plus one (+1) for each adjustment, a final value of “D” will be displayed on the secure display 104. The displayed value for the adjusted digit can sequentially as follows: W, X, Y, Z, A, B, C, D. In accordance with this example, the random character generator can generate characters from among the following sequence A, B, C, D, E, F, G, H, I, J, K, L, M, N, O, P, Q, R, S, T, U, V, W, X, Y, Z. Other example sequences of letters can also be defined. With that example sequence, however, the final value of “D” could be achieved by using the password adjustment means eighteen (18) times to produce an offset value of minus one (−1) for each adjustment.

In accordance with an example in which the random character generator comprises a random symbol generator that generates symbols from a sequence of QWERTY keyboard symbols (such as, ˜, !, @, #, $, %, ̂, &, *), if a first, randomly generated start value is “$” and the toggle wheel is adjusted eight (8) times to provide eight (8) offsets of plus one (+1), a final value of “#” will be displayed on the secure display 104. The displayed value for the adjusted digit can sequentially as follows: %, ̂, &, *, ˜, !, @, #. Other example sequences of symbols can also be defined. With that example sequence, however, the final value of “#” could be achieved by using the password adjustment means one time to produce an offset value of minus one (−1) for that adjustment.

In accordance with the one or more example embodiments in which an adjustment offset value is plus one (+1) or minus one (−1), the information conveying either +1 or −1 can be arranged in various ways. For example, a single data bit can covey the information. In that regard, the data bit can be mapped such that the data bit set to zero (0) represents −1 and the data bit set to one (1) represents +1. Alternatively, the data bit can be mapped such that the data bit set to zero (0) represents +1 and the data bit set to one (1) represents −1. As another example, the information conveying +1 or −1 can be data representing an ASCII character (such as + to represent +1, and − to represent −1). The data representing the ASCII character could be transmitted as a decimal, hexagonal, or octagonal number.

Regardless of the manner in which the information representing the value of +1 or −1 is conveyed between the mobile phone 102 and the secure device 104, the secure device 104 can use the conveyed information to select a next or previous character in a sequence of characters relative to a displayed character of the sequence.

It is to be appreciated that in this example embodiment, the password adjustment means 108 is exemplified as a toggle wheel. However, further embodiments are not be limited to this specific implementation and the password adjustment means 108 may be provided in the form of any touch screen with visible cues in the form of an input method such as a slider 118 or slider adjustment buttons 114, 116. It is further to be appreciated that the adjustment means 108 may be provided in the form of a the press of a specified key (like a space bar) or the press of any key (unrelated to the PIN that is being selected) on the keyboard of the non-secure device, a mouse scroll, a mouse button click, a gesture or any touch on a track pad or touch screen or another means of data input such as voice, or by triggering or activating an accelerometer by any physical device movements

In response to an adjustment being communicated to the secure device 104, the adjusted character will be displayed on the secure device 104, for a predetermined amount of time. Following which, the displayed adjusted character will be replaced with the unrelated symbol after a predetermined amount of time. Furthermore, in the event that the password entry mechanism 108 is idle for a certain amount of time, the displayed, adjusted character will be replaced by an unrelated typographical symbol, such as an asterisk (*) or the like. The unrelated symbol is typically a symbol not in the sequence of characters comprising the displayed adjusted character.

A correct password corresponds to a PIN of a banking card 124 of the user. The banking card 124 will conventionally be placed in a slot provided in the secure device 104. If the password displayed on the secure device 104 corresponds to the PIN of the banking card 124 an underlying financial transaction between the banking account of the user and an external vendor is authorized and facilitated.

### II. Example Operation

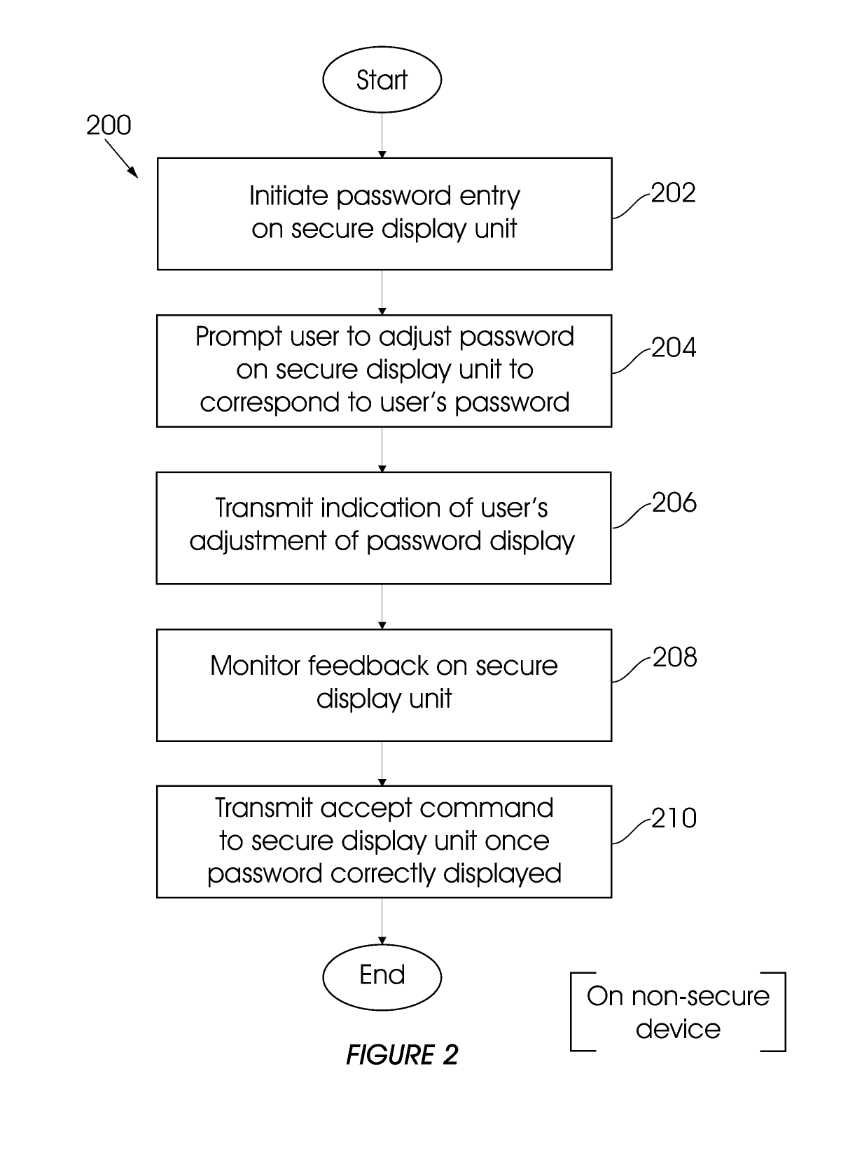

With reference to FIG. 2, a method of enabling a secure password entry using a non-secure device of the system 100 as shown in FIG. 1 is generally indicated by reference numeral 200.

At block 202, a non-secure device in the example form of a mobile device 102 initiates a password entry transaction with a secure display unit 104. In this regard, it is to be appreciated that the mobile device 102 and the secure display unit 104 can communicate with each other using a determined protocol and in accordance with the security restrictions of the secure display unit 104.

At block 204, after the secure display unit 104 computes and displays a random value for the password which cannot be accessed by the mobile device 102 but is visible to the user controlling the mobile device 102, the mobile device 102 prompts the user to adjust the password displayed on the secure display unit 104. The user will then adjust the password displayed in increments of plus one (+1) or some other positive offset, or decrements of minus one (−1) or some other negative offset through the movement of a scroll wheel or other password entry mechanism. It is appreciated that, at block 204, the user will be prompted in this manner until the user adjusts the password displayed on the secure display unit 104 so that it matches the user's password. It is to be appreciated that in this example embodiment, the password adjustment means 108 is exemplified as a scroll wheel. However, further embodiments are not be limited to this specific implementation and the password entry mechanism may be provided in the form of any touch screen with visible cues in the form of an input method such as a slider 118 or slider adjustment buttons 114, 116. It is further to be appreciated that the adjustment means 108 may be provided in the form of a the press of a specified key (like a space bar) or the press of any key (unrelated to the PIN that is being selected) on the keyboard of the non-secure device, a mouse scroll, a mouse button click, a gesture or any touch on a track pad or touch screen or another means of data input such as voice, or by triggering or activating an accelerometer by any physical device movements

After the user has adjusted the password, at block 206 the mobile device 102 will transmit an indication of the user's action (for example, up and down clicks) to the secure display unit 104 upon which the secure display unit 104 will update its display to present the newly adjusted password.

In this regard, it is important to note that, in accordance with some of the example embodiments, the password displayed on the secure display unit 104 can only be adjusted in one direction, namely forward or backward. In other words, should the user rest a digit of the displayed password on an incorrect number and the password entry moves onto a second, subsequent digit the user will be necessitated to start the password entry process from scratch to remedy the incorrect first digit having been entered. In accordance with other embodiments, any digit of the password displayed on the secure display unit 104 can be adjusted prior to or after adjustment of any other digit(s) of the displayed password. Moreover, any one or more of the digits can be adjusted before and after at least one intervening digit adjustment.

At block 208, the mobile device 102 will enable the user to control the input mechanism on the device and monitor the feedback on the secure display unit 104 in order to affect the outcome.

The mobile device 102, at block 210, will then transmit an accept command to the secure display unit once the user is satisfied that the correct password has been displayed on the secure display unit. The accept command can be generated and transmitted in response to selection of the submit button 110.

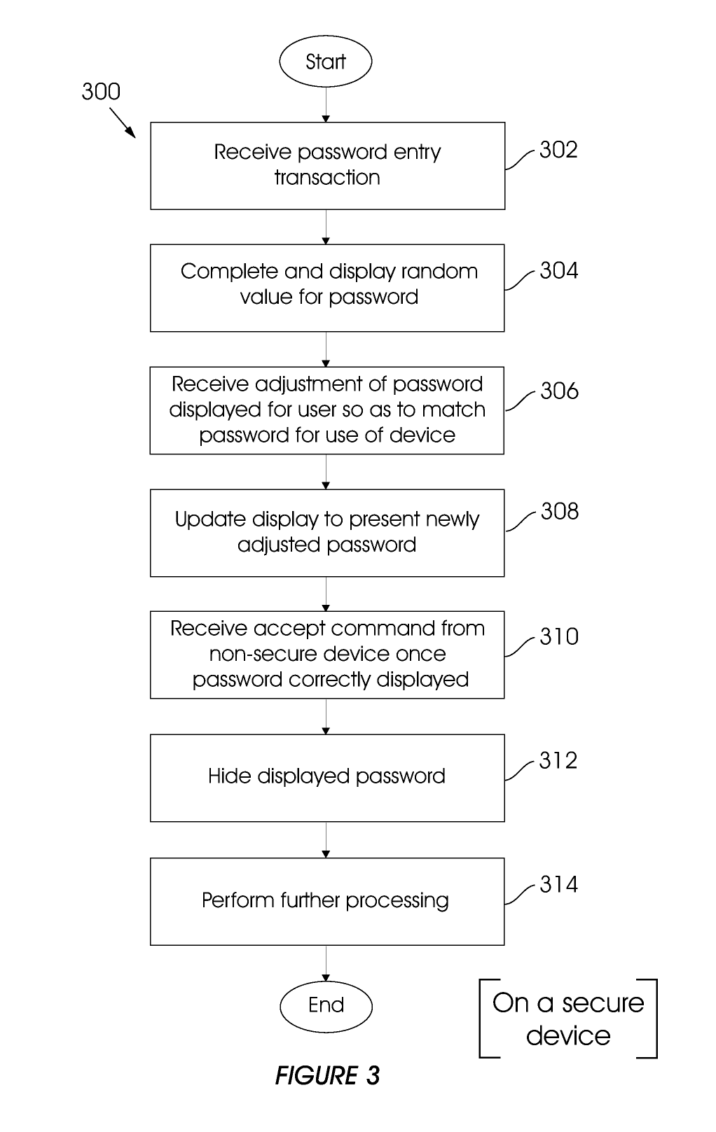

With reference to FIG. 3, a method of enabling a secure password entry using a non-secure device of the system 100 as shown in FIG. 1 is generally indicated by reference numeral 300.

At block 302, the secure display unit 104 receives a password entry transaction from an accompanying mobile device 102.

The display unit 104, at block 304, then computes and displays a random value for the password. It is to be appreciated that this random value is not accessible by the mobile device 102 itself, but is visible to the user controlling the mobile device 102.

At block 306, the display unit 104 will receive from the mobile device 102 an adjustment (in the form of an indication of a number up or down clicks, each click corresponding to an increment of +1 or some other offset) of the password it is displaying so that the password of the user is matched on the display unit 104.

The display unit 104 will then update its display to present the newly adjusted password, at block 308.

Once the user is satisfied that the correct password is displayed on the display unit 104, the display unit 104 will, at block 310, receive an accept command from the mobile device 102.

In terms of block 312, it is to be appreciated that the display unit 104 can hide the displayed password by replacing each of the digits displayed by an unrelated typographical character. Furthermore, the display unit 104 can, in terms of block 314, also then continue with further processing as required. It is to be appreciated that the unrelated typographical character is not to be a numeric equivalent of the password of the user nor any derivation of the user's password.

In response to or after receiving the accept command, display unit 104 can generate an output signal and transmit an output signal to effect a financial transaction between a banking account and an external vendor. Generating an output signal and effecting a financial transaction can include approving an underlying transaction between a bank account associated with a banking card and an external, peripheral system. In an alternative arrangement, mobile device 102 can generate or transmit the output signal to effect the financial transaction.

### III. Example Diagrammatic Representation

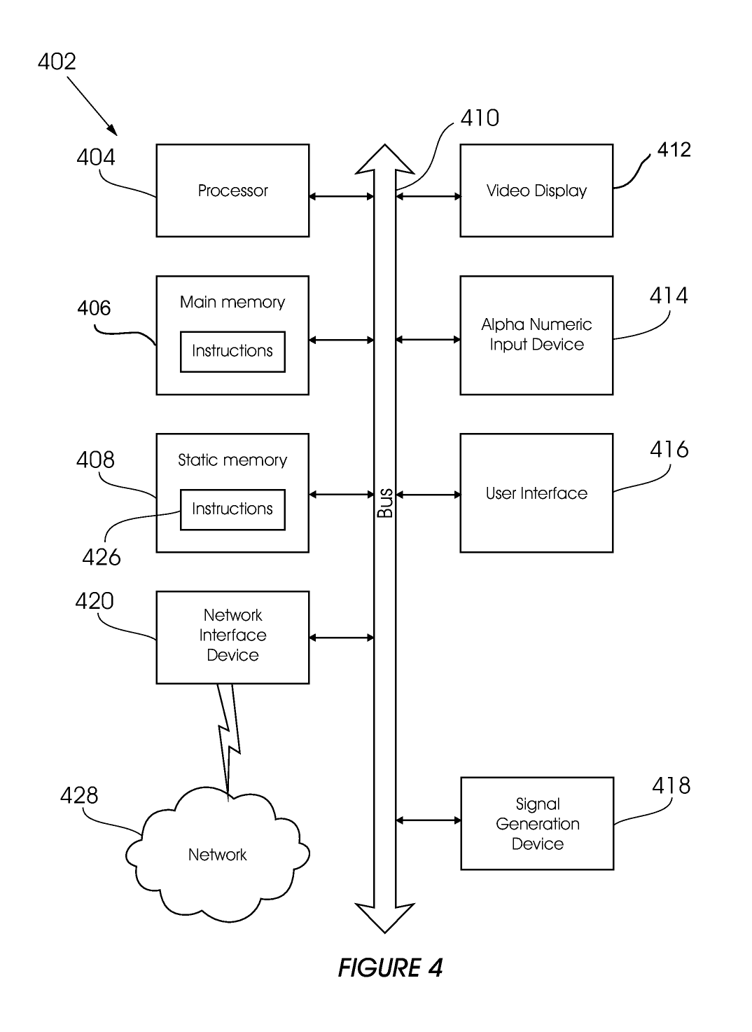

In FIG. 4, a diagrammatic representation of a non-secure device 102 in the example form of a mobile device 402 within which a set of instructions, for causing the machine to perform any one or more of the methodologies discussed herein, may be executed. As mentioned above, in alternative embodiments, the machine operates as a standalone device or may be connected to other devices (such as the peripheral display unit 104). In accordance, with one or more of the example embodiments, the peripheral display unit 104 is removably attachable to mobile device 104 or communicates over a wireless interface.

In more detail, the example mobile device 402 includes a conventional processor 404 (e.g., a central processing unit (CPU), a graphics processing unit (GPU) or both), a main memory 406 and a static memory 408, which communicate with each other via a bus 410. The mobile device 402 may further include a conventional video display unit 412 e.g., a liquid crystal display. The mobile device 402 also includes a conventional alphanumeric input device (e.g., a touch screen or keyboard panel) 414, a user interface (UI) 416, a signal generation device 418 (e.g., a speaker) and a network interface device 420. The alphanumeric input device can input various keyboard symbols in addition to letters and numbers.

The main memory component 406 includes one or more sets of instructions and data structures (e.g., a software component 426) and, when configured in accordance with an example embodiment, the software component 426 comprises a variety of instructions and data sets which correspond to functional tasks performed by the processor 404. The functional tasks in question relate to sending a signal from a non-secure device 102 to a secure device 104, so as to adjust a random character displayed on the secure device 104 so as to facilitate a secure financial transaction, as described in more detail with reference to FIGS. 1, 2 and 3.

The software component 426 may also reside, completely or at least partially, within the static memory component 408 and the processor 404 also constituting machine-readable media. The software 426 may further be transmitted or received over a network 428 via the network interface device 420 utilizing any one of a number of well-known or later-developed transfer protocols (e.g., HTTP). The network 428 may include at least a portion of the Internet.

In accordance with the example embodiments described herein, a memory or memory component can comprise a non-transitory computer-readable storage medium readable by a processor, such as processor 404. Each memory or memory component can comprise volatile and/or non-volatile storage components, such as optical, magnetic, organic or other memory or disc storage, which can be integrated in whole or in part with a processor, such as processor 404.

### IV. Additional Example Embodiments

This section of the detailed description includes multiple enumerated examples. Unless explicitly limited to use of specific offset(s), these enumerated examples can be used with any of the offsets described herein.

1. A method comprising: computing and displaying one or more random characters on a first device, adjusting said displayed one or more random characters on said first device, in response to user input on a second device, and generating an output signal, in response to said user input correctly adjusting said displayed one or more random characters to one or more digits of a password.

2. A method as recited in example 1, wherein said output signal is configured to effect a financial transaction between a banking account associated with a banking card and an external vendor.

3. A method as recited in any one of examples 1 and 2, further comprising said second device transmitting to said first device an indication of said user input.

4. A method as recited in any one of examples 1, 2, and 3, further comprising said second device sending an event signal to said first device causing it to increment at least one of said one or more random characters displayed on said first device by an entropy of either plus one or minus one.

5. A method as recited in example 2, wherein said password corresponds to a Personal Identification Number (PIN) of said banking card.

6. A method as recited in any one of examples 1, 2, 3, and 5, wherein adjusting said displayed one or more random characters on said first device comprises adjusting each of said displayed one or more random characters in increments of plus one or decrements of minus one.

7. A method as recited in example 6, wherein said user input includes manipulating a password entry mechanism on said second device so as to adjust each of said one or more random characters displayed on said first device in increments of plus one or decrements of minus one.

8. A method as recited in example 7, further comprising said second device communicating each adjustment increment or decrement to said first device and said first device adjusting said one or more displayed random characters in response to each adjustment increment or decrement communicated by said second device.

9. A method as recited in any one of examples 1 through 8, further comprising said second device transmitting an accept command to said first device in response to a user acceptance.

10. A method as recited in any one of examples 1 through 9, further comprising: replacing one or more digits of said one or more random characters displayed on said first device with one or more unrelated symbols after a predetermined amount of time.

11. A method as recited in any one of examples 1 through 10, wherein each random character of the one or more random characters is a random number.

12. A method as recited in any one of examples 1 through 10, wherein each random character of the one or more random characters is a random letter.

13. A method as recited in any one of examples 1 through 10, wherein each random character of the one or more random characters is a random symbol.

14. A method as recited in any one of examples 1 through 10, wherein each random character of the one or more random characters is one of a random number, letter, or symbol.

15. A system comprising: a first device, including: (i) a random character generator, (ii) a receiver, operable to receive event signals from a second device, and (iii) a display, operable to display one or more random characters generated by said random character and to adjust said displayed one or more random characters in response to said event signals from said second device, said second device, including: (i) a user interface, operable to receive adjustment requests to adjust said one or more random characters displayed on said first device, and (ii) a transmitter, operable to transmit said event signals to said first device, in response to said adjustment requests, wherein said system is operable to generate an output signal, in response to a password being correctly displayed on said first device.

16. A system as recited in example 15, wherein said display is operable to restrict visibility of said displayed one or more random characters.

17. A system as recited in any one of examples 15 and 16, wherein said display is operable to display one or more unrelated symbols in place of one or more digits of said one or more random characters after a predetermined amount of time.

18. A system as recited in any one of examples 15, 16, and 17, wherein said first device and said second device form a single, integrated unit.

19. A system as recited in any one of examples 15, 16, 17, and 18, wherein said first device is tamper proof.

20. A system as recited in any one of examples 15 through 19, wherein each random character of the one or more random characters is a random number.

21. A system as recited in any one of examples 15 through 19, wherein each random character of the one or more random characters is a random letter.

22. A system as recited in any one of examples 15 through 19, wherein each random character of the one or more random characters is a random symbol.

23. A system as recited in any one of examples 15 through 19, wherein each random character of the one or more random characters is one of a random number, letter, or symbol.

24. A method comprising: initiating a financial transaction in response to a signal received from a system, said system comprising a first device in communication with a second device, wherein said first device includes: (i) a random character generator, (ii) a receiver, operable to receive event signals from said second device, and a display, operable to display one or more random characters generated by said random character generator and to adjust said displayed one or more random characters in response to said event signals; wherein said second device includes: (i) a user interface, operable to receive adjustment requests to adjust said one or more random characters displayed on said first device, and (ii) a transmitter, operable to transmit said event signals to said first device, in response to said adjustment requests.

25. A method of example 24, wherein the random character generator comprises a random number generator.

26. A method of example 24, wherein the random character generator comprises a random letter generator.

27. A method of example 24, wherein the random character generator comprises a random symbol generator.

28. A method of example 24 or 25, wherein each random character of the one or more random characters is a random number.

29. A method of example 24 or 26, wherein each random character of the one or more random characters is a random letter.

30. A method of example 24 or 27, wherein each random character of the one or more random characters is a random symbol.

31. A method of example 24, wherein each random character of the one or more random characters is one of a random number, letter, or symbol.

32. An article of manufacture comprising a non-transitory computer readable storage medium having computer readable instructions embodied therein that, when executed by a computer, implements a method comprising: (i) computing and displaying one or more random characters on a first device, (ii) adjusting said displayed one or more random characters on said first device, in response to user input on a second device, (iii) replacing one or more digits of said one or more random characters displayed on said secure device with one or more unrelated symbols after a predetermined amount of time, and (iv) generating an output signal, in response to said user input correctly adjusting said displayed one or more random characters to one or more digits of a password.

33. An article of manufacture as recited in example 32, wherein each random character of the one or more random characters is a random number.

34. An article of manufacture as recited in example 32, wherein each random character of the one or more random characters is a random letter.

35. An article of manufacture as recited in example 32, wherein each random character of the one or more random characters is a random symbol.

36. An article of manufacture as recited in example 32, wherein each random character of the one or more random characters is one of a random number, letter, or symbol.

37. A method, comprising: (i) displaying one or more random characters on a display, (ii) receiving user input via a user interface, (iii) adjusting said one or more random characters based on said user input to provide one or more adjusted characters, (iv) displaying said one or more adjusted characters on said display, (v) receiving an acceptance via said user interface, wherein said acceptance is indicative of said one or more adjusted characters matching a password, and (vi) generating an output signal in response to said acceptance, wherein said output signal is configured to effect a financial transaction.

38. The method of example 37, wherein receiving user input via a user interface comprises receiving one or more incremental adjustments via said user interface.

39. The method of any one of examples 37 and 38, further comprising: in response to each incremental adjustment, incrementally adjusting one or more characters being displayed on said display to provide one or more incrementally-adjusted characters and displaying said one or more incrementally-adjusted characters on said display.

40. The method of example 39, wherein incrementally adjusting one or more characters being displayed on said display comprises increasing or decreasing at least one of said one or more characters by an offset amount.

41. The method of example 40, wherein said offset amount is one.

42. The method of example 39, wherein said one or more random characters include a plurality of digits and said user interface includes an adjustment mechanism for incrementally adjusting at least one digit in said plurality of digits.

43. The method of example 39, wherein displaying said one or more incrementally-adjusted characters on said display comprises displaying said one or more incrementally-adjusted characters on said display for a predetermined period of time.

44. The method of example 43, further comprising displaying one or more unrelated symbols on said display in place of said one or more incrementally-adjusted characters after said predetermined period of time.

45. The method as recited in any one of examples 37 through 44, wherein each random character of the one or more random characters is a random number.

46. The method as recited in any one of examples 37 through 44, wherein each random character of the one or more random characters is a random letter.

47. The method as recited in any one of examples 37 through 44, wherein each random character of the one or more random characters is a random symbol.

48. The method as recited in any one of examples 37 through 44, wherein each random character of the one or more random characters is one of a random number, letter, or symbol.

49. The method as recited in any one of examples 37 through 45, wherein each adjusted character of the one or more adjusted characters is an adjusted number.

50. The method as recited in any one of examples 37 through 44 or 46, wherein each adjusted character of the one or more adjusted characters is an adjusted letter. 51. The method as recited in any one of examples 37 through 44 or 47, wherein each adjusted character of the one or more adjusted characters is an adjusted symbol.

52. The method as recited in any one of examples 37 through 44 or 48, wherein each adjusted character of the one or more adjusted characters is one of an adjusted number, letter, or symbol.

53. A system, comprising: a random character generator, a display, a user interface, a processor, a memory, instructions stored in said memory and executable by said processor to cause said system to perform functions comprising: (i) displaying on said display one or more random characters generated by said random character generator, (ii) receiving user input via said user interface, (iii) adjusting said one or more random characters based on said user input to provide one or more adjusted characters, (iv) displaying said one or more adjusted characters on said display, (v) receiving an acceptance via said user interface, wherein said acceptance is indicative of said one or more adjusted characters matching a password, and (vi) generating an output signal in response to said acceptance, wherein said output signal is configured to effect a financial transaction.

54. The system of example 53, wherein receiving user input via said user interface comprises receiving one or more incremental adjustments via said user interface.

55. The system of example 54, wherein said functions further comprise: in response to each incremental adjustment, incrementally adjusting one or more characters being displayed on said display to provide one or more incrementally-adjusted characters and displaying said one or more incrementally-adjusted characters on said display.

56. The system of example 55, wherein incrementally adjusting one or more characters being displayed on said display comprises increasing or decreasing at least one of said one or more characters by an offset amount.

57. The system of example 56, wherein said offset amount is one.

58. The system of example 55, wherein said one or more random characters include a plurality of digits and said user interface includes an adjustment mechanism for incrementally adjusting at least one digit in said plurality of digits.

59. The system of example 55, wherein displaying said one or more incrementally-adjusted characters on said display comprises displaying said one or more incrementally-adjusted characters on said display for a predetermined period of time.

60. The system of example 59, wherein said functions further comprise displaying one or more unrelated symbols on said display in place of said one or more incrementally-adjusted characters after said predetermined period of time.

61. The system as recited in any one of examples 53 through 60, wherein each random character of the one or more random characters is a random number.

62. The system as recited in any one of examples 53 through 60, wherein each random character of the one or more random characters is a random letter.

63. The system as recited in any one of examples 53 through 60, wherein each random character of the one or more random characters is a random symbol.

64. The system as recited in any one of examples 53 through 60, wherein each random character of the one or more random characters is one of a random number, letter, or symbol.

64. The system as recited in any one of examples 53 through 61, wherein each adjusted character of the one or more adjusted characters is an adjusted number.

66. The system as recited in any one of examples 53 through 60 or 62, wherein each adjusted character of the one or more adjusted characters is an adjusted letter.

67. The system as recited in any one of examples 53 through 60 or 63, wherein each adjusted character of the one or more adjusted characters is an adjusted symbol.

68. The system as recited in any one of examples 53 through 60 or 64, wherein each adjusted character of the one or more adjusted characters is one of an adjusted number, letter, or symbol.

69. An article of manufacture comprising a non-transitory computer readable storage medium having instructions embodied therein that, when executed by a computer, cause said computer to perform functions comprising: (i) displaying one or more random characters on a display, (ii) receiving user input via a user interface, (iii) adjusting said one or more random characters based on said user input to provide one or more adjusted characters, (iv) displaying said one or more adjusted characters on said display, (v) receiving an acceptance via said user interface, wherein said acceptance is indicative of said one or more adjusted characters matching a password, and (vi) generating an output signal in response to said acceptance, wherein said output signal is configured to effect a financial transaction.

70. The article of manufacture of example 34, wherein receiving user input via a user interface comprises receiving one or more incremental adjustments via said user interface.

71. The article of manufacture of example 35, wherein said functions further comprise: in response to each incremental adjustment, incrementally adjusting one or more characters being displayed on said display to provide one or more incrementally-adjusted characters and displaying said one or more incrementally-adjusted characters on said display.

72. The article of manufacture of example 36, wherein incrementally adjusting one or more characters being displayed on said display comprises increasing or decreasing at least one of said one or more characters by an offset amount.

73. The article of manufacture of example 37, wherein said offset amount is one.

74. The article of manufacture of example 36, wherein said one or more random characters include a plurality of digits and said user interface includes an adjustment mechanism for incrementally adjusting at least one digit in said plurality of digits.

75. The article of manufacture of example 36, wherein displaying said one or more incrementally-adjusted characters on said display comprises displaying said one or more incrementally-adjusted characters on said display for a predetermined period of time.

76. The article of manufacture of example 40, wherein said functions further comprise displaying one or more unrelated symbols on said display in place of said one or more incrementally-adjusted characters after said predetermined period of time.

77. The article of manufacture as recited in any one of examples 69 through 76, wherein each random character of the one or more random characters is a random number.

78. The article of manufacture as recited in any one of examples 69 through 76, wherein each random character of the one or more random characters is a random letter.

79. The article of manufacture as recited in any one of examples 69 through 76, wherein each random character of the one or more random characters is a random symbol.

80. The article of manufacture as recited in any one of examples 69 through 76, wherein each random character of the one or more random characters is one of a random number, letter, or symbol.

81. The article of manufacture as recited in any one of examples 69 through 77, wherein each adjusted character of the one or more adjusted characters is an adjusted number.

82. The article of manufacture as recited in any one of examples 69 through 76 or 78, wherein each adjusted character of the one or more adjusted characters is an adjusted letter.

83. The article of manufacture as recited in any one of examples 69 through 76 or 79, wherein each adjusted character of the one or more adjusted characters is an adjusted symbol.

84. The article of manufacture as recited in any one of examples 69 through 76 or 80, wherein each adjusted character of the one or more adjusted characters is one of an adjusted number, letter, or symbol.

85. A method, comprising: (i) computing a random value for an initial password, (ii) displaying said initial password on a display, (iii) receiving user input via a user interface, (iv) adjusting said initial password based on said user input to provide an adjusted password, (v) displaying said adjusted password on said display, (vi) receiving an acceptance via said user interface, wherein said acceptance is indicative of said adjusted password matching a user password, and (vii) generating an output signal in response to said acceptance, wherein said output signal is configured to effect a financial transaction.

86. The method of example 85, wherein receiving user input via a user interface comprises receiving one or more incremental adjustments via said user interface.

87. The method of example 86, further comprising: in response to each incremental adjustment, incrementally adjusting a password being displayed on said display to provide an incrementally-adjusted password and displaying said incrementally-adjusted password on said display.

88. The method of claim 87, wherein incrementally adjusting said password comprises moving forward or backward one character in a sequence of characters.

89. The method of claim 88, wherein the sequence of characters comprises a sequence of numbers or a sequence of letters.

90. The method of claim 85, wherein generating said output signal comprises a device including said display generating said output signal.

91. The method of claim 85, wherein generating said output signal comprises a device including said user interface generating said output signal.

92. The method of claim 85, further comprising:

transmitting said output signal to a network.

93. The method of claim 85, wherein receiving user input via a user interface comprises receiving information indicating to move one position backwards within a sequence of characters.

94. The method of claim 93, further comprising:

moving backwards from a current position within said sequence of characters to a new position within said sequence of characters; and

selecting a character of said sequence of characters from said new position;

wherein displaying said adjusted password on said display comprises displaying said character selected from said new position of said sequence of characters.

95. The method of claim 94, wherein moving backwards from said current position to said new position comprises moving from a first end of said sequence of characters to a second end of said sequence of characters.

96. The method of claim 85, wherein receiving user input via a user interface comprises receiving information indicating to move one position forward within a sequence of characters.

97. The method of claim 96, further comprising:

moving forward from a current position within said sequence of characters to a new position within said sequence of characters; and

selecting a character of said sequence of characters from said new position;

wherein displaying said adjusted password on said display comprises displaying said character selected from said new position of said sequence of characters.

98. The method of claim 97, wherein moving forward from said current position to said new position comprises moving from a first end of said sequence of characters to a second end of said sequence of characters.

99. A system, comprising: a display, a user interface, a processor, a memory, instructions stored in said memory and executable by said processor to cause said system to perform functions comprising: (i) computing a random value for an initial password, (ii) displaying said initial password on said display, (iii) receiving user input via said user interface, (iv) adjusting said initial password based on said user input to provide an adjusted password, (v) displaying said adjusted d password on said display, (vi) receiving an acceptance via said user interface, wherein said acceptance is indicative of said adjusted password matching a user password, and (vii) generating an output signal in response to said acceptance, wherein said output signal is configured to effect a financial transaction.

100. The system of example 99, wherein receiving user input via said user interface comprises receiving one or more incremental adjustments via said user interface.

101. The system of example 100, wherein said functions further comprise: in response to each incremental adjustment, incrementally adjusting a password being displayed on said display to provide an incrementally-adjusted password and displaying said incrementally-adjusted password on said display.

102. An article of manufacture comprising a non-transitory computer readable storage medium having instructions embodied therein that, when executed by a computer, cause said computer to perform functions comprising: (i) computing a random value for an initial password, (ii) displaying said initial password on a display, (iii) receiving user input via a user interface, (iv) adjusting said initial password based on said user input to provide an adjusted password, (v) displaying said adjusted password on said display, (vi) receiving an acceptance via said user interface, wherein said acceptance is indicative of said adjusted password matching a user password, and (vii) generating an output signal in response to said acceptance, wherein said output signal is configured to effect a financial transaction.

103. The article of manufacture of example 102, wherein receiving user input via a user interface comprises receiving one or more incremental adjustments via said user interface.

104. The article of manufacture of example 103, wherein said functions further comprise: in response to each incremental adjustment, incrementally adjusting a password being displayed on said display to provide an incrementally-adjusted password and displaying said incrementally-adjusted password on said display.

105. A method comprising: (i) computing and displaying, by a first device, one or more random characters, (ii) adjusting, by said first device, said displayed one or more random characters, in response to user input on a second device, and (iii) generating, by said first device, an output signal, in response to said user input correctly adjusting said displayed one or more random characters to one or more digits of a password.

106. A method as recited in example 105, wherein said output signal is configured to effect a financial transaction between a banking account associated with a banking card and an external vendor.

107. A method as recited in any one of examples 105 and 106, further comprising said second device transmitting to said first device an indication of said user input.

108. A method as recited in any one of examples 105, 106, and 107, further comprising said second device sending an event signal to said first device causing it to increment at least one of said one or more random characters displayed on said first device by an entropy of either plus one or minus one.

109. A method as recited in example 106, wherein said password corresponds to a Personal Identification Number (PIN) of said banking card.

110. A method as recited in any one of examples 105, 106, 107, and 109, wherein adjusting said displayed one or more random characters to one or more digits of a password comprises adjusting each of said displayed one or more random characters in increments of plus one or decrements of minus one.

111. A method as recited in example 110, wherein said user input includes manipulating a password entry mechanism on said second device so as to adjust each of said one or more random characters displayed on said first device in increments of plus one or decrements of minus one.

112. A method as recited in example 111, further comprising said second device communicating each adjustment increment or decrement to said first device and said first device adjusting said one or more displayed random characters in response to each adjustment increment or decrement communicated by said second device.

113. A method as recited in any one of examples 105 through 112, further comprising said second device transmitting an accept command to said first device in response to a user acceptance.

114. A method as recited in example 105, further comprising transmitting, by said first device, said output signal to a network for transmission to an external vendor computing device that can effect a financial transaction between a banking account associated with a banking card and an external vendor.

115. A method as recited in any one of examples 105 through 114, further comprising: replacing one or more digits of said one or more random characters displayed on said first device with one or more unrelated symbols after a predetermined amount of time.

116. A method as recited in any one of examples 105 through 115, wherein each random character of the one or more random characters is a random number.

117. A method as recited in any one of examples 105 through 115, wherein each random character of the one or more random characters is a random letter.

118. A method as recited in any one of examples 105 through 115, wherein each random character of the one or more random characters is a random symbol.

119. A method as recited in any one of examples 105 through 1115, wherein each random character of the one or more random characters is one of a random number, letter, or symbol.

120. A method, comprising: (i) computing, by a first device, a random value for an initial password, (ii) displaying, by a display of said first device, said initial password, (iii) receiving, by said first device, user input entered via a user interface, (iv) adjusting, by said first device, said initial password based on said user input to provide an adjusted password, (v) displaying said adjusted password on said display, (vi) receiving an acceptance via said user interface, wherein said acceptance is indicative of said adjusted password matching a user password, and (vii) generating an output signal in response to said acceptance, wherein said output signal is configured to effect a financial transaction.

121. The method of example 120, wherein receiving user input via a user interface comprises receiving one or more incremental adjustments via said user interface.

122. The method of example 121, further comprising: in response to each incremental adjustment, incrementally adjusting a password being displayed on said display to provide an incrementally-adjusted password and displaying said incrementally-adjusted password on said display.

123. The method of example 120, wherein receiving user input via a user interface comprises receiving one or more decremental adjustments via said user interface.

124. The method of example 123, further comprising: in response to each decremental adjustment, decrementally adjusting a password being displayed on said display to provide a decrementally-adjusted password and displaying said decrementally-adjusted password on said display.

125. The method of example 123, wherein receiving user input via a user interface comprises receiving one or more incremental adjustments via said user interface and receiving one or more decremental adjustments via said user interface.

126. The method of example 125, further comprising: in response to each decremental adjustment, decrementally adjusting a respective portion of a password being displayed on said display, and in response to each incremental adjustment, incrementally adjusting a respective different portion of said password being displayed on said display to provide said adjusted password.

127. The method of any one of examples 120 through 126, wherein generating said output signal comprises said first device generating said output signal.

128. The method of any one of examples 120 through 126, wherein generating said output signal comprises a second device, comprising said user interface, generating said output signal.

### V. Conclusion

Example embodiments have been described above. Those skilled in the art will understand that changes and modifications can be made to the described embodiments without departing from the true scope and spirit of the present invention, which is defined by the claims.

We claim:

1. A method, comprising:
displaying one or more random characters on a display;
receiving user input via a user interface;
adjusting said one or more random characters based on said user input to provide one or more adjusted characters;
displaying said one or more adjusted characters on said display;
receiving an acceptance via said user interface, wherein said acceptance is indicative of said one or more adjusted characters matching a password; and
generating an output signal in response to said acceptance, wherein said output signal is configured to effect a financial transaction.

2. The method of claim 1, wherein receiving user input via a user interface comprises receiving one or more incremental adjustments via said user interface.

3. The method of claim 2, further comprising:
in response to each incremental adjustment, incrementally adjusting one or more characters being displayed on said display to provide one or more incrementally-adjusted characters and displaying said one or more incrementally-adjusted characters on said display.

4. The method of claim 3, wherein incrementally adjusting one or more characters being displayed on said display comprises increasing or decreasing at least one of said one or more characters by an offset amount.

5. The method of claim 4, wherein said offset amount is one.

6. The method of claim 3, wherein said one or more random characters include a plurality of digits and said user interface includes an adjustment mechanism for incrementally adjusting at least one digit in said plurality of digits.

7. The method of claim 3, wherein displaying said one or more incrementally-adjusted characters on said display comprises displaying said one or more incrementally-adjusted characters on said display for a predetermined period of time.

8. The method of claim 7, further comprising displaying one or more unrelated symbols on said display in place of said one or more incrementally-adjusted characters after said predetermined period of time.

9. A system, comprising:
a random character generator;
a display;
a user interface;
a processor;
a memory;
instructions stored in said memory and executable by said processor to cause said system to perform functions comprising:
displaying on said display one or more random characters generated by said random character generator;
receiving user input via said user interface;
adjusting said one or more random characters based on said user input to provide one or more adjusted characters;
displaying said one or more adjusted characters on said display;
receiving an acceptance via said user interface, wherein said acceptance is indicative of said one or more adjusted characters matching a password; and
generating an output signal in response to said acceptance, wherein said output signal is configured to effect a financial transaction.

10. The system of claim 9, wherein receiving user input via said user interface comprises receiving one or more incremental adjustments via said user interface.

11. The system of claim 10, wherein said functions further comprise:
in response to each incremental adjustment, incrementally adjusting one or more characters being displayed on said display to provide one or more incrementally-adjusted characters and displaying said one or more incrementally-adjusted characters on said display.

12. The system of claim 11, wherein incrementally adjusting one or more characters being displayed on said display comprises increasing or decreasing at least one of said one or more characters by an offset amount.

13. The system of claim 12, wherein said offset amount is one.

14. The system of claim 11, wherein said one or more random characters include a plurality of digits and said user interface includes an adjustment mechanism for incrementally adjusting at least one digit in said plurality of digits.

15. The system of claim 11, wherein displaying said one or more incrementally-adjusted characters on said display comprises displaying said one or more incrementally-adjusted characters on said display for a predetermined period of time.

16. The system of claim 15, wherein said functions further comprise displaying one or more unrelated symbols on said display in place of said one or more incrementally-adjusted characters after said predetermined period of time.

17. An article of manufacture comprising a non-transitory computer readable storage medium having instructions embodied therein that, when executed by a computer, cause said computer to perform functions comprising:
displaying one or more random characters on a display;
receiving user input via a user interface;
adjusting said one or more random characters based on said user input to provide one or more adjusted characters;
displaying said one or more adjusted characters on said display;
receiving an acceptance via said user interface, wherein said acceptance is indicative of said one or more adjusted characters matching a password; and
generating an output signal in response to said acceptance, wherein said output signal is configured to effect a financial transaction.

18. The article of manufacture of claim 17, wherein receiving user input via a user interface comprises receiving one or more incremental adjustments via said user interface.

19. The article of manufacture of claim 18, wherein said functions further comprise:
in response to each incremental adjustment, incrementally adjusting one or more characters being displayed on said display to provide one or more incrementally-adjusted characters and displaying said one or more incrementally-adjusted characters on said display.

20. The article of manufacture of claim 19, wherein incrementally adjusting one or more characters being displayed on said display comprises increasing or decreasing at least one of said one or more characters by an offset amount.

21. The article of manufacture of claim 20, wherein said offset amount is one.

22. The article of manufacture of claim 19, wherein said one or more random characters include a plurality of digits and said user interface includes an adjustment mechanism for incrementally adjusting at least one digit in said plurality of digits.

23. The article of manufacture of claim 19, wherein displaying said one or more incrementally-adjusted characters on said display comprises displaying said one or more incrementally-adjusted characters on said display for a predetermined period of time.

24. The article of manufacture of claim 23, wherein said functions further comprise displaying one or more unrelated symbols on said display in place of said one or more incrementally-adjusted characters after said predetermined period of time.
